(19) United States
(12) Patent Application Publication
(10) Pub. No.: US 2024/0416234 A1
(43) Pub. Date: Dec. 19, 2024

(54) CLOUD-BASED IMAGE PROCESSING METHOD, SYSTEM, APPARATUS AND COMPUTER-READABLE STORAGE MEDIUM

(71) Applicant: Tencent Technology (Shenzhen) Company Limited, Shenzhen (CN)

(72) Inventor: Zhipeng Gong, Shenzhen (CN)

(21) Appl. No.: 18/814,765

(22) Filed: Aug. 26, 2024

Related U.S. Application Data
(63) Continuation of application No. PCT/CN2023/129615, filed on Nov. 3, 2023.

(30) Foreign Application Priority Data
Dec. 30, 2022 (CN) 2022117435965

(51) Int. Cl. A63F 13/52; G06T 9/00; G06T 15/04

(52) U.S. Cl. CPC A63F 13/52; G06T 9/00; G06T 15/04

(57) ABSTRACT

An image processing method, system, storage medium, and apparatus are provided herein. The method includes: obtaining, by a cloud server, a texture handle and a synchronization object of game texture data for a target game running on the cloud server; obtaining a reading result of an image encoder for the synchronization object; obtaining, using the reading result, a rendering completion status for the game picture from the synchronization object; obtaining the game picture indicated by the texture handle based on the rendering completion status indicating that rendering of the game picture has been completed by using the game texture data; and encoding, using the image encoder, the game picture.

### RELATED APPLICATION

This application is a continuation application of PCT Application PCT/CN2023/129615, filed Nov. 03, 2023, which claims priority to Chinese Patent Application No. 202211743596.5 filed on Dec. 30, 2022, each of which is entitled “IMAGE PROCESSING METHOD AND APPARATUS, COMPUTER DEVICE, COMPUTER-READABLE STORAGE MEDIUM, AND COMPUTER PROGRAM PRODUCT” and is incorporated herein by reference in its entirety.

### FIELD

This application relates to the field of computer technologies, and relates to, but not limited to, a cloud-based image processing method, system, apparatus, computer device, computer-readable storage medium, and computer program product.

### BACKGROUND

At present, cloud game solutions mainly involve cloud processing of inventory games. Usually, a game plug-in provided by a game engine is directly integrated into a game, a game picture is acquired based on the game plug-in, and the game picture is encoded and then streamed for audio and video streams.

However, in the solution of game cloud processing based on the game plug-in, the game plug-in needs to be responsible for rendering the game picture, encoding the game picture, and transmitting the audio and video streams after the encoding to the game client. That is, the game plug-in needs to be configured with many functions such as encoding and real-time communication protocol. The development of the game plug-in is relatively difficult, which will cause the problem of relatively low encoding efficiency of the game picture.

### SUMMARY

One or more aspects described herein provide an image processing method and apparatus, a computer device, a computer-readable storage medium, and a computer program product, which support transmitting a texture handle and a synchronization object of game texture data in a cloud game to an image encoder for encoding a game picture, making the processing process of the cloud game more flexible and convenient, thereby improving the encoding efficiency of the game picture of the cloud game.

An image processing method, performed by a cloud server, is described herein, the method including: obtaining, by a cloud server, a texture handle and a synchronization object of game texture data for a target game running on the cloud server, the texture handle indicating a game picture rendered based on the game texture data, and the synchronization object indicating a rendering completion status for the game picture by the game texture data; obtaining a reading result of an image encoder for the synchronization object; obtaining, using the reading result, a rendering completion status for the game picture from the synchronization object; obtaining the game picture indicated by the texture handle based on the rendering completion status indicating that rendering of the game picture has been completed by using the game texture data; and encoding, using the image encoder, the game picture.

An image processing apparatus is described herein, the apparatus including: an acquisition unit, configured to acquire a texture handle and a synchronization object of game texture data in a target cloud game, the texture handle being configured for associating a game picture rendered based on the game texture data, and the synchronization object being configured for indicating a rendering completion status for the game picture by the game texture data; the acquisition unit being further configured to acquire a reading result of an image encoder for the synchronization object, and acquire the rendering completion status for the game picture from the synchronization object according to the reading result; and a processing unit, configured to acquire the associated game picture through the texture handle when the acquired rendering completion status indicates that rendering of the game picture has been completed by using the game texture data, and encode the acquired game picture by using the image encoder.

A computer device is also described herein, the computer device including a memory and a processor, the memory storing a computer program, the computer program, when executed by the processor, causing the processor to perform the image processing method described herein.

A non-transitory computer-readable storage medium is also described herein, the computer-readable storage medium storing a computer program, the computer program, when read and executed by a processor of a computer device, causing the computer device to perform the image processing method described herein.

A computer program product is described herein, the computer program product including a computer program, the computer program being stored in a computer-readable storage medium. A processor of a computer device reads the computer program from the computer-readable storage medium, and executes the computer program, to cause the computer device to perform the image processing method described herein.

In some scenarios, first, a texture handle and a synchronization object of game texture data in a target cloud game may be acquired, the texture handle being configured for associating a game picture rendered based on the game texture data, and the synchronization object being configured for indicating a rendering completion status for the game picture by the game texture data; then a reading result of an image encoder for the synchronization object may be acquired, and the rendering completion status for the game picture may be acquired from the synchronization object according to the reading result; and finally, the associated game picture may be acquired through the texture handle when the acquired rendering completion status indicates that rendering of the game picture has been completed by using the game texture data, and the acquired game picture may be encoded by using the image encoder. It can be seen that in the rendering process of the game picture, a separate image encoder is responsible for encoding the game picture, so that the encoding process is more flexible. In addition, it is unnecessary to wait for completion of rendering of the game picture before the game picture is transmitted to the image encoder for encoding, but the game handle and the synchronization object associated with the game texture data configured for rendering the game picture are shared with the image encoder. In this way, when the image encoder determines, based on the synchronization object, that the game picture has been rendered, the image encoder can encode the associated game picture based on the texture handle, making the processing process of the cloud game more flexible and convenient, thereby improving the encoding efficiency of the game picture of the target cloud game.

### BRIEF DESCRIPTION OF THE DRAWINGS

To describe the technical solutions presented herein, the following briefly introduces the accompanying drawings, wherein:

FIG. 1 is a schematic principle diagram of one or more aspects of an example of an image processing method;

FIG. 2 is a schematic architectural diagram of one or more aspects of an example of an image processing system for cloud gaming;

FIG. 3 is a schematic flowchart of one or more aspects of an example of an image processing method for cloud gaming;

FIG. 4 is a schematic diagram of an example scenario of a game picture;

FIG. 5 is a schematic structural diagram of one or more aspects of an example of a cloud server

FIG. 6 is a schematic interaction flowchart of one or more aspects of an example of an image processing method for cloud gaming;

FIG. 7 is a schematic flowchart of one or more aspects of an example of reading a synchronization object;

FIG. 8 is a schematic diagram of one or more aspects of an example of a scenario of an image processing method for cloud gaming;

FIG. 9 is a schematic structural diagram of one or more aspects of an example of an image processing apparatus for cloud gaming; and

FIG. 10 is a schematic structural diagram of one or more aspects of an example of a computer device.

### DETAILED DESCRIPTION

One or more aspects of the invention are described in detail herein, and examples thereof are shown in the accompanying drawings. Unless indicated otherwise, same numbers in different accompanying drawings represent the same or similar elements.

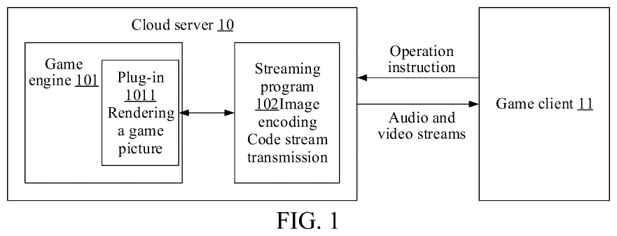

The image processing method provided herein may be an image processing method for cloud gaming. This application provides an image processing method for a cloud game scene, which supports separation of a rendering process of a game picture and an encoding process of the game picture after rendering in a cloud game in a cloud game scene. In other words, an engine plug-in of a cloud server of a target cloud game is responsible for the rendering process of the game picture, and a separate game process (program) is responsible for the encoding of the game picture, which can make the engine plug-in more lightweight, more convenient to be integrated into various game engines, and more flexible to be deployed. FIG. 1 is a schematic principle diagram of one or more aspects of an example of an image processing method. The principle of the image processing method is generally described with reference to FIG. 1.

As shown in FIG. 1, two independent game processes may be run in a cloud server 10. For example, a game engine 101 integrated with a plug-in 1011 may run in a game process of a target cloud game, and a streaming program 102 configured with an image encoder may run in another game process of the target cloud game. The engine plug-in may be responsible for rendering a game picture, and the streaming program may be responsible for encoding the game picture (image encoding), and transmitting the encoded code streams (audio and video streams) obtained after the encoding to a game client 11. The principle of the image processing method for cloud gaming is generally as follows: the engine plug-in in the cloud server may share a texture handle and a synchronization object to the streaming program, the texture handle and synchronization object being information corresponding to game texture data configured for rendering the game picture of the target cloud game. The image encoder in the streaming program may acquire a rendering completion status for the game picture based on the synchronization object, the synchronization object being configured for indicating the rendering completion status for the game picture by the game texture data. When the acquired rendering completion status indicates that rendering of the game picture has been completed by using the game texture data, the image encoder may acquire, through the texture handle, the game picture obtained through the rendering in the engine plug-in, and the acquired game picture may be encoded by using the image encoder. After encoding is completed, the streaming program may also transmit audio and video streams obtained after the encoding to the game client, and the game client may output the corresponding game picture based on the audio and video streams.

The rendering of the game picture may be executed by the plug-in, and the encoding process of the game picture and the subsequent code stream transmission process may be executed by a separate streaming program. Compared with the conventional game processing processes (rendering process, encoding process, and transmission process) which are all executed by the engine plug-in, a more lightweight plug-in is described herein. Because the plug-in only needs to be responsible for the rendering of the game picture, it is more convenient to integrate the plug-in into various game engines, the deployment of the plug-in is more flexible, and the development difficulty is relatively low compared to conventional plug-ins. The plug-in and the streaming program may implement the encoding of the game picture based on the shared texture handle and synchronization object, and it may be unnecessary to wait for completion of rendering of the game picture before the game picture is transmitted to the image encoder for encoding, but the game handle associated with the game texture data configured for rendering the game picture and the synchronization object configured for indicating the rendering completion status for the game picture may be shared with the image encoder, so that after the image encoder determines, based on the synchronization object, that the game picture has been rendered, the image encoder may acquire the associated game picture based on the texture handle, and encode the game picture, making the processing process of the cloud game more flexible and convenient.

To enable the technical solutions provided herein to be understood more clearly, the technical terms involved in the foregoing image processing method for cloud gaming are discussed in detail below. The relevant technical terms involved in the image processing method for cloud gaming include, but are not limited to: cloud computing technology and blockchain technology.

For the cloud computing technology, cloud gaming is first explained:

The image processing method provided herein may be applied to a cloud game scene. The cloud gaming, which may also be referred to as gaming on demand, is an online gaming technology based on the cloud computing technology. The cloud gaming technology enables thin clients with relatively limited graphics processing and data computing capabilities to run high-quality games. In a cloud game scene, the game is not run on a game terminal of a player (for example, the game client in FIG. 1), but in a cloud server, and the cloud server renders a game scene/game picture into video and audio streams (audio and video streams), and transmits the video and audio streams (audio and video streams) to the game client through a network. The game client does not need to have strong graphics computing and data processing capabilities, but only needs to have the basic streaming media playback capability and the capability to acquire operation instructions inputted by the game player and transmit the operation instructions to the cloud server.

Based on this, with reference to the game client 11 (cloud game client) and the cloud server 10 shown in FIG. 1 as an example, the general principle of implementation of the cloud game is as follows: First, for the game client: it may support a game player to enter the cloud game through the game client for playing. During playing, the game player may trigger and perform various operations on the game picture, such as a screen touch operation and a mouse and keyboard operation. The game client may generate operation instructions based on these operations and may report these operation instructions to the cloud server. Secondly, for the cloud server: it may start game processes of the cloud game for clients participating in the cloud game; for example, a game player enters the cloud game based on a game client for playing, and in this case, the cloud server may start and run two game processes (a game process in which the engine plug-in is located and a game process in which the image encoder is located) in the cloud, and may provide the game client with an encoding result (audio and video streams) of the game picture of the cloud game based on the two game processes. Finally, for the game client: after receiving the audio and video streams transmitted by the cloud server, it may display the corresponding game picture. When the game player performs various operations on the game picture (such as a screen touch operation and a mouse and keyboard operation), the game client may generate operation instructions again based on these operations and may report the operation instructions to the cloud server. The cloud server may refresh the game picture of the cloud game according to the operation instructions in the corresponding game processes, and then may return the refreshed game picture to the client for display. Operations performed by a user on the game picture may include a movement operation, a selection operation, and the like. For example, the user moves a game character on the game picture from a first position on the game picture to a second position on the game picture. In another example, the user selects (such as single-clicks, double-clicks, or long-presses) a game control on the game picture.

The game process mentioned above may alternatively be understood as a cloud game instance. One game process is one cloud game instance. Cloud games are deployed and run on cloud game instances. Cloud game instances represent virtual computing resources. The virtual computer resources may include: a set of basic computing components such as a CPU, an operating system, a network, a disk, and a graphics processing unit (GPU). That is, the game process is a cloud game that is successfully started and can be actually operated.

Subsequently, the cloud computing is explained: From the foregoing content, it can be seen that the server of the target cloud game (the cloud server) may provide a graphics processing capability and a data computing capability based on the cloud computing technology, to support the smooth operation of the target cloud game. For example, graphics processing and data computing processes involve a large amount of data calculation and data storage services, which require high computer operating costs. Therefore, the one or more aspects described herein may implement corresponding processes such as picture rendering and image encoding based on the cloud computing technology. Cloud computing is a computing mode, in which computing tasks are distributed on a resource pool formed by a large quantity of computers, so that various application systems can acquire computing power, storage space, and information services according to requirements. A network that provides resources is referred to as a “cloud”. For a user, resources in a “cloud” seem to be infinitely expandable, and can be acquired readily, used on demand, expanded readily, and paid for according to usage. As a basic capability provider of cloud computing, a cloud computing resource pool (which is referred to as a cloud platform for short) is built, which is generally referred to as an infrastructure as a service (IaaS) platform, and a plurality of types of virtual resources are deployed in the cloud computing resource pool for external customers to choose for use.

For the blockchain technology, a blockchain is a new application mode of computer technologies such as distributed data storage, peer to peer (P2P) transmission, a consensus mechanism, and an encryption algorithm. The blockchain is essentially a decentralized database and is a string of data blocks (which may also be referred to as blocks) generated through association by using a cryptographic method. Each data block includes information of a batch of network transactions, the information being configured for verifying the validity of information of the data block (anti-counterfeiting) and generating a next data block. The blockchain uses cryptography to ensure that data cannot be tampered with or forged. Data such as game texture data, texture handles, and synchronization objects involved in the image processing process of the cloud game may be transmitted to the blockchain for storage. Based on the blockchain's characteristics such as being tamper-proof and being traceable, the security of the image processing process can be improved, and leakage of game data can be avoided.

In one of more scenarios, relevant data such as object information may be involved. When applied to a specific product or technology, target object permission or consent may need to be obtained, and the collection, use, and processing of relevant data may need to comply with relevant laws, regulations, and standards of relevant countries and regions.

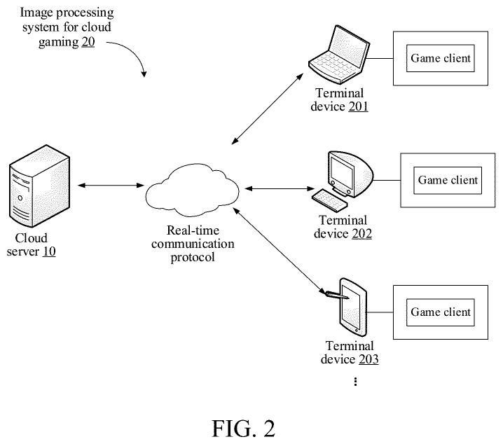

The architecture of the image processing system are discussed in detail below in combination with the foregoing description of the image processing method and the related technical terms involved. FIG. 2 is a schematic architectural diagram of one or more aspects of an example an image processing system for cloud gaming. The image processing system for cloud gaming 20 may include at least: a terminal device cluster and a cloud server 10. The terminal device cluster may include: a terminal device 201, a terminal device 202, a terminal device 203, and/or the like. A communication connection may be established between the cloud server 10 and any terminal device (for example, the terminal device 201) in the terminal device cluster in a wired or wireless manner. Data (for example, image encoded data of game texture data) may be transmitted between the cloud server 10 and the terminal device 201 based on a real-time communication protocol. A game client of the target cloud game may be running in any terminal device in the terminal device cluster. The game client may be configured to decode and play the audio and video streams of the target cloud game transmitted by the cloud server 10 to output the decrypted game picture in the game client. The quantity of terminal devices in the terminal device cluster is used as an example, and the quantity of terminal devices is not limited.

The terminal device 201, the terminal device 202, the terminal device 203, and/or the like may include, but are not limited to: a mobile phone, a tablet computer, a notebook computer, a palmtop computer, a mobile Internet device (MID), a smart voice interaction device, an in-vehicle terminal, a roadside device, an aircraft, a wearable device, a smart home appliance, a wearable device with an image processing function such as a smart watch, a smart bracelet, or a pedometer, and/or the like.

The cloud server 10 may be an independent physical server, or may be a server cluster or a distributed system formed by a plurality of physical servers, may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform, or the like.

Subsequently, by using any terminal device (for example, the terminal device 201) in the image processing system as an example, the data interaction process between the terminal device 201 and the cloud server 10 is correspondingly introduced:

After receiving an operation instruction inputted by a target game player, the terminal device 201 may transmit the operation instruction to the cloud server 10. After receiving an operation instruction for the target cloud game, the cloud server 10 may acquire a texture handle and a synchronization object of corresponding game texture data in the target cloud game, the texture handle being configured for associating a game picture obtained through rendering based on the game texture data, and the synchronization object being configured for indicating a rendering completion status for the game picture by the game texture data. Subsequently, the cloud server 10 may acquire a reading result of an image encoder for the synchronization object, and may acquire the rendering completion status for the game picture from the synchronization object according to the reading result. Finally, the cloud server 10 may acquire the associated game picture through the texture handle when the acquired rendering completion status indicates that rendering of the game picture has been completed by using the game texture data, and may encode the acquired game picture by using the image encoder. Subsequently, the cloud server 10 may transmit the image encoded data obtained after the encoding is completed to the terminal device 201, so that the terminal device 201 may output the corresponding game picture after decoding the image encoded data.

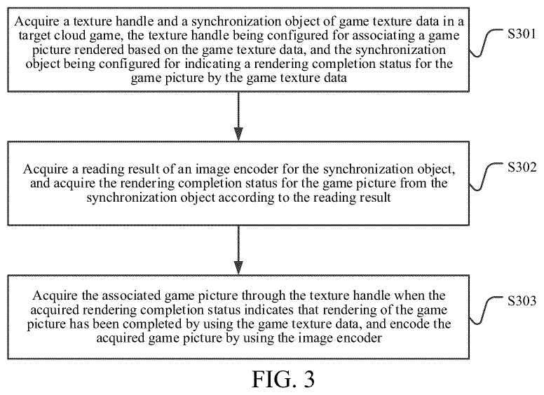

In one instance, the image processing method may be for cloud gaming and may be performed by a computer device. The computer device may be the cloud server 10 or a different computing device. FIG. 3 is a schematic flowchart of one or more aspects of an example of an image processing method. The image processing method may be applied by the cloud server 10 in the image processing system for cloud gaming shown in FIG. 2. The image processing method for cloud gaming includes, but is not limited to, the following operations S301 to S303:

S301: Acquire a texture handle and a synchronization object of game texture data in a target cloud game, the texture handle associating a game picture rendered based on the game texture data, and the synchronization object indicating a rendering completion status for the game picture by the game texture data.

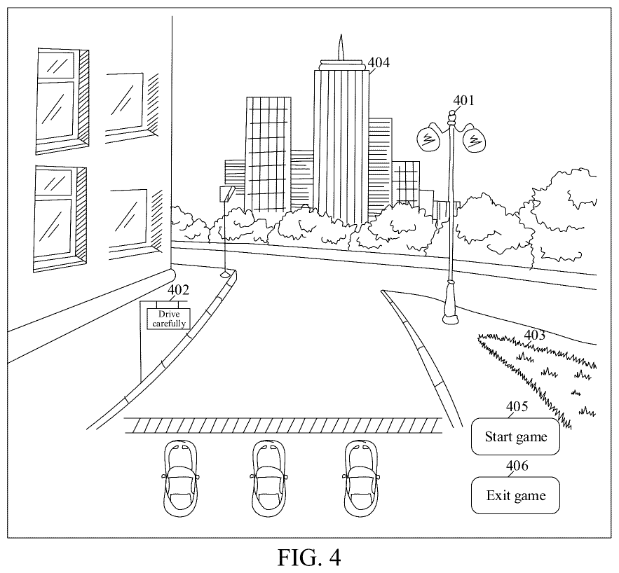

The game texture data may refer to data configured for rendering the game picture, that is, data configured for rendering the game content in the target cloud game to obtain the game picture. Data formats of the game texture data may include a two-dimensional array, a three-dimensional array, and/or the like. The game texture data may store parameters such as a color, a position, and/or a background environment of the corresponding game picture. The game content may include scene content and user interface content. The scene content refers to any one or more types of content related to the game scene, such as trees, roads, and/or buildings in the game. The user interface content refers to content in the game that may be operated by the user, such as a virtual keyboard and a virtual control in the game. FIG. 4 is a schematic diagram of one or more aspects of a scenario of a game picture. In the game picture shown in FIG. 4, a street light 401, a traffic sign 402, grass 403, a building construction 404, and the like are scene content, and virtual controls such as “Start game” 405 and “Exit game” 406 are user interface content. In addition, the game picture refers to a picture that can be displayed in the game client (for example, the traffic picture shown in FIG. 4). The game picture may be obtained by superimposing the game scene picture and the user interface picture. The game scene picture may be obtained through rendering the scene content, and the user interface picture may be obtained through rendering the user interface content.

One piece of game texture data may correspond to one game picture, and the texture handle of the game texture data may indicate an identifier of the game texture data. That is, one texture handle may correspond to an identifier of one game picture. For example, the current game picture is an n^{th} frame of picture in the target cloud game, then a texture handle (identifier) of corresponding game texture data configured for rendering the game picture may be n, n being a positive integer.

The synchronization object refers to a special object created during in the rendering process of the game picture based on the game texture data. The synchronization object may indicate the rendering completion status for the game picture by the game texture data. That is, the synchronization object may be understood as an indication message in the process of rendering the game picture. For example, when the synchronization object is used as an indication message in the process of rendering the game picture, the indication message may be displayed in formats such as a rendering progress (percentage) and a rendering instruction (character string). For example, if the rendering completion status for the current game picture indicated by the synchronization object is displayed as 100%, it may indicate that the current game picture has been rendered; and if the rendering completion status for the current game picture indicated by the synchronization object is displayed as 50%, it indicates that the current game picture has not been completely rendered. In another example, when the rendering completion status for the current game picture indicated by the synchronization object is displayed as “end”, it indicates that the current game picture has been rendered; and when the rendering completion status for the current game picture indicated by the synchronization object is displayed as “loading”, it indicates that the current game picture has not been completely rendered.

In one implementation, the game texture data mentioned above may be created by an engine plug-in (such as a Pixel Streaming plug-in or a Render Streaming plug-in) in the cloud server corresponding to the target cloud game. In addition to the engine plug-in, the cloud server may further include the image encoder. The image encoder may be, for example, a graphic processing unit (GPU). Moreover, the engine plug-in and image encoder in the cloud server may belong to two independent game processes, where one game process may be configured for executing one or more game processing logics in the target cloud game. For example, the game process in which the engine plug-in is located may be responsible for the rendering logic of the game picture; and in another example, the game process in which the image encoder is located may be responsible for the encoding logic of the game picture that has been rendered. The engine plug-in and the image encoder may interact based on a process communication protocol. For example, after creating the game texture data, the engine plug-in may transmit the texture handle of the game texture data and the corresponding synchronization object to the image encoder through the process communication protocol. The process communication protocol may be an Internet process connection (IPC) protocol (a shared “named pipe” resource). The IPC protocol may be a named pipe opened for implementing communication between different processes (the engine plug-in and the image encoder), and by providing a trustworthy user name and password, the two connected parties may establish a secure channel and may use the channel to exchange data (such as the texture handle of the game texture data and the corresponding synchronization object).

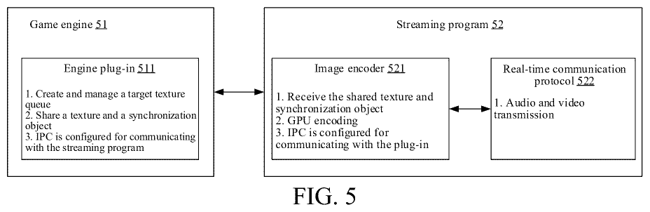

FIG. 5 is a schematic structural diagram of one or more aspects of an example of a cloud server. As shown in FIG. 5, the cloud server may include an engine plug-in and an image encoder (for example, a GPU encoder). The game process in which the engine plug-in 511 is located (that is, a game engine 51) may be mainly responsible for the following game processing logics: creating and managing a target texture queue, where the game texture data refers to a to-be-rendered game texture acquired from the target texture queue; sharing a texture and a synchronization object, where the engine plug-in sharing the texture and the synchronization object may include: sharing data such as the texture handle of the game texture data, the game picture rendered based on the game texture data, and the synchronization object of the game texture data; and performing communication with the image encoder based on the IPC protocol. In addition, the game process in which the image encoder 521 is located (that is, a streaming program 52) may be mainly responsible for the following game processing logics: receiving the texture handle of the game texture data and the synchronization object of the game texture data shared by the engine plug-in; a GPU encoder encoding the game picture; and communicating with the engine plug-in 511 based on the IPC protocol. Finally, the image encoder may further transmit, based on a real-time communication protocol 522, the audio and video streams obtained through encoding to the game client. Both the image encoding logic and the audio and video transmission logic may be provided by the streaming program.

S302: Acquire a reading result of an image encoder for the synchronization object, and acquire the rendering completion status for the game picture from the synchronization object according to the reading result.

When the reading result for the synchronization object is a reading success, the image encoder may successfully acquire the rendering completion status for the game picture from the synchronization object. In this case, the acquiring may include the following operations: parsing the synchronization object through the image encoder, and acquiring the rendering completion status for the game picture from the parsed synchronization object.

When the reading result is a reading failure, the image encoder may not be able to successfully acquire the rendering completion status for the game picture from the synchronization object. In this case, the image encoder may notify the CPU of the cloud server of execution of a reading operation on the synchronization object. The CPU may be the processing core of a computer device (that is, the cloud server). During the processing, the CPU may be suitable for implementing one or more program instructions, for example, suitable for loading and executing one or more program instructions to perform the read operation on the synchronization object. Therefore after it is determined that the image encoder cannot successfully read the synchronization object, a prompt message may be transmitted to the CPU, the prompt message being configured for prompting the CPU to perform a reading operation and a parsing operation on the synchronization object to acquire the rendering completion status for the game picture. For example, the synchronization object may be parsed through the CPU; then the rendering completion status for the game picture obtained after the CPU parses the synchronization object is transmitted to the image encoder, for the image encoder to obtain the rendering completion status for the game picture.

In this instance, it may be necessary to first determine, based on the synchronization object, whether the game picture has been rendered. After it is determined that a rendering operation has been performed on the game picture, the image encoder may encode the game picture that has been rendered. Therefore, whether the image encoder can successfully acquire the rendering completion status for the game picture from the synchronization object will be preferentially determined. If the image encoder can successfully acquire the rendering completion status, the image encoder will be responsible for reading and parsing the synchronization object to acquire the rendering completion status for the game picture. This method allows the image encoder to directly perform a series of operations such as reading the synchronization object and encoding the game picture based on the image encoder having the capability to read the synchronization object. Therefore, giving priority to reading the synchronization object based on the image encoder can make the entire image processing process more coherent, thereby improving the processing efficiency. In addition, if the image encoder cannot successfully read the synchronization object, the CPU of the cloud server may read and parse the synchronization object, and then the CPU may notify the image encoder of the rendering completion status for the game picture, to ensure that even if the image encoder cannot successfully read the synchronization object, it can still acquire the rendering completion status for the game picture, to trigger the execution of subsequent encoding operations.

Different types of synchronization objects may also be created based on different synchronization mechanisms, and different synchronization mechanisms may be correspondingly provided by different encoding interfaces. For example, the encoding interface may be a graphics application program interface (API). The synchronization mechanisms refer to mechanisms/criteria for creating different types of synchronization objects, and a synchronization object created based on a certain synchronization mechanism allows reading on the synchronization object based on the same synchronization mechanism. For example, a device 1 creates a synchronization object “a” based on synchronization mechanism A, then the device 1 transmits the synchronization object to a device 2, and if the device 2 needs to successfully read the synchronization object “a”, the device 2 needs to support or implement the synchronization mechanism A (that is, the device 2 needs to have an encoding interface that can provide the synchronization mechanism A), to successfully read the synchronization object “a.” One synchronization mechanism may be configured for creating one or more types of synchronization objects. First, an encoding interface supported by the image encoder may be acquired, one encoding interface supporting parsing synchronization objects generated by one or more corresponding synchronization mechanisms; then a reference synchronization mechanism associated with the synchronization object corresponding to the game texture data may be acquired, where the reference synchronization mechanism refers to a synchronization mechanism configured for creating the synchronization object, and as described above, the synchronization object may be created based on the reference synchronization mechanism (for example, the synchronization mechanism A); and finally, when the synchronization mechanisms supported by the encoding interface include the reference synchronization mechanism, it may be determined that the reading result of the image encoder for the synchronization object is a reading success; otherwise, it may be determined that the reading result of the image encoder for the synchronization object is a reading failure.

For example, for the correspondence between synchronization mechanisms and encoding interfaces, reference may be made to Table 1 below:

TABLE 1
Correspondence between synchronization mechanisms and encoding interfaces

| Encoding | Shared texture | Synchronization |
|---|---|---|
| interface | (game texture data) | mechanism |
| Direct3D11/ | SharedHandle | SharedFence |
| Direct3D12 | | |
| Vulkan | VK_KHR_external_memory_win32 | VK_KHR_external_semaphore_win32 |
| | VK_KHR_external_memory_fd | VK_KHR_external_semaphore_fd |
| OpenGL ES | EGLImage | EGL_KHR_fence_sync |

As shown in Table 1 above, sharing textures refer to sharing game texture data, a texture handle of the game texture data, and a synchronization object corresponding to game texture data between different game processes. Sharing textures may include sharing the texture handle of the game texture data and the synchronization object corresponding to the game texture data between the engine plug-in and the image encoder. Subsequently, after the image encoder determines, based on the synchronization object, that the game picture has been rendered, the game texture data may alternatively be acquired from the engine plug-in based on the texture handle. Different encoding interfaces may be configured for different types of game texture data to realize texture sharing between the engine plug-in and the image encoder. In addition, different encoding interfaces may correspondingly provide different synchronization mechanisms to create corresponding types of synchronization objects, to realize interaction of the synchronization objects between the engine plug-in and the image encoder. After the engine plug-in creates the corresponding type of synchronization object based on a different synchronization mechanism, the image encoder may first invoke the corresponding encoding interface to read the synchronization object in the encoding process. Because different types of synchronization objects are created based on different types of encoding interfaces, the image encoder needs to implement the corresponding type of encoding interface before reading the synchronization object created by the engine plug-in. Compared with directly creating a synchronization object that can be read in a plurality of game processes (threads), the manner in which corresponding types of synchronization objects are created based on synchronization mechanisms provided by different encoding interfaces further ensures the reliability and effectiveness of the engine plug-in and the image encoder in the process of sharing synchronization objects. For example, if the encoding interface is a Direct3D11 or Direct3D12 interface, the type of the game texture data shared between the engine plug-in and the image encoder may be SharedHandle, and the type of the synchronization object shared between the engine plug-in and the image encoder may be SharedFence; in another example, if the encoding interface is a Vulkan interface (a cross-platform two-dimensional and three-dimensional graphics API), the type of the game texture data shared between the engine plug-in and the image encoder may be “VK_KHR_external_memory_win32” (or “VK_KHR_external_memory_fd”), and the type of the synchronization object shared between the engine plug-in and the image encoder may be “VK_KHR_external_semaphore_win32” (or “VK_KHR_external_semaphore_fd”); and in another example, if the encoding interface is an OpenGL for embedded systems (OpenGL ES, a graphics API developed for embedded devices such as game consoles) interface, the type of the game texture data shared between the engine plug-in and the image encoder may be “EGLImage”, and the type of the synchronization object shared between the engine plug-in and the image encoder may be “EGL_KHR_fence_sync”.

Based on the foregoing manner of sharing the texture handle and the synchronization object, the engine plug-in may transmit the texture handle and the synchronization object of the game texture data configured for picture rendering to the image encoder (for example, a GPU encoder) in a video memory sharing manner. Video memory sharing is an effective way to improve the performance of graphics cards by using a part of the internal memory in the cloud server as video memory. That is, the texture handle and the synchronization object of the game texture data created by the engine plug-in in the cloud server (all these data are stored in the internal memory) may be directly shared with the image encoder, without the need for the image encoder to additionally copy the corresponding data (that is, the texture handle and the synchronization object of the game texture data) from the video memory, which can avoid additional video memory copy operations during image encoding, and simplify the operations, thereby improving the processing efficiency of the image encoding process.

S303: Acquire the associated game picture through the texture handle when the acquired rendering completion status indicates that rendering of the game picture has been completed by using the game texture data, and encode the acquired game picture by using the image encoder.

As described above, when it is determined based on the synchronization object that the acquired rendering completion status indicates that the game picture has been rendered by using the game texture data (for example, when the rendering progress is 100%), the associated game picture that has been rendered may be acquired through the texture handle. Subsequently, the acquired game picture may be encoded by using the image encoder. Encoding the game picture may include compressing the game picture. The game picture may be encoded by using standard encoding parameters, to obtain image encoded data (such as audio streams and video streams) of the game picture. For example, the standard encoding parameters may include, but not limited to, at least one of the following: a sampling rate, a bit width, the quantity of channels, or the total quantity of sampling points within a target time length; The sampling rate, which may also be referred to as a sampling frequency, refers to the quantity of sampling points extracted from the game picture within a unit time (for example, one second) and forming a discrete sequence. For example, 48,000 sampling points are extracted from the game picture in one second. The bit width refers to the quantity of bits occupied by each sampling point. For example, each sampling point occupies 4 bits or 8 bits. The quantity of channels refers to the quantity of channels during playback of the audio corresponding to the game picture. For example, the quantity of channels being 1 indicates a single channel, and the quantity of channels being 2 indicates dual channels. The total quantity of sampling points within the target time length refers to the total quantity of sampling points during sampling on the game picture within the target time length (for example, ten milliseconds). Subsequently, after the encoding is completed, the image encoded data obtained after encoding the game picture may also be transmitted to the game client, so that the game client may output the game picture of the target cloud game after decoding the received image encoded data.

First, a texture handle and a synchronization object of game texture data corresponding to a target cloud game may be acquired, the texture handle being configured for associating a game picture obtained through rendering based on the game texture data, and the synchronization object being configured for indicating a rendering completion status for the game picture by the game texture data; then a reading result of an image encoder for the synchronization object may be acquired, and the rendering completion status for the game picture may be acquired from the synchronization object according to the reading result; and finally, the associated game picture may be acquired through the texture handle when the acquired rendering completion status indicates that rendering of the game picture has been completed by using the game texture data, and the acquired game picture may be encoded by using the image encoder. It can be seen that in the rendering process of the game picture, a separate image encoder may be responsible for encoding the game picture, so that the encoding process is more flexible. In addition, it is unnecessary to wait for completion of rendering of the game picture before the game picture is transmitted to the image encoder for encoding, but the game handle and the synchronization object associated with the game texture data configured for rendering the game picture may be shared with the image encoder. In this way, after the image encoder determines, based on the synchronization object, that the game picture has been rendered, the image encoder may encode the associated game picture based on the texture handle, making the processing process of the cloud game more flexible and convenient, thereby improving the encoding efficiency of the game picture of the target cloud game.

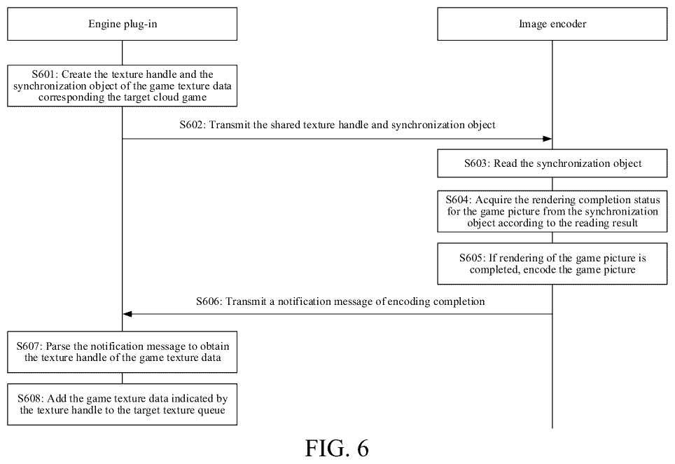

From the above, it can be seen that the image processing method includes the structural improvement of the cloud game server, and the engine plug-in and the image encoder are separated in two game processes, to jointly provide the game client with a flexible and convenient image processing method in a cloud game scene. Subsequently, FIG. 6 is a schematic interaction flowchart of one or aspects of an example of an image processing method for cloud gaming. The method may be applied by the cloud server in the image processing system shown in FIG. 2, and the method may involve an interaction process between the engine plug-in and the image encoder of the cloud server. The interaction method of image processing for cloud gaming includes, but not limited to, the following operations S601 to S608:

S601: The engine plug-in creates the texture handle and the synchronization object of the game texture data corresponding the target cloud game.

Operations for the engine plug-in to create the texture handle and the synchronization object of the game texture data corresponding to the target cloud game may be: (1) Create a target texture queue, where the engine plug-in may arrange a plurality of pieces of created game texture data in sequence, to obtain the target texture queue. In some instances, the engine plug-in may perform arrangement based on the order in which the game picture corresponding to each piece of game texture data appears in a target cloud game scene, to obtain the target texture queue. For example, if first game texture data is configured for rendering a first frame of game picture of the target cloud game, and second game texture data is configured for rendering a second frame of game picture of the target cloud game, the first game texture data may be placed in the target texture queue first, and then the second game texture data may be placed in the target texture queue. By analogy, after the plurality of pieces of created game texture data of the target cloud game are arranged, the target texture queue may be obtained. (2) Render the game picture according to the game texture data, and create the texture handle through association for the game picture corresponding to the game texture data. The texture handle created through association may be configured for indicating the game picture corresponding to the game texture data, that is, the corresponding game picture can be acquired through association based on the texture handle. Because the texture handle can be understood as an identifier similar to an integer, the corresponding game picture can be correspondingly indicated based on a texture handle with a relatively small data volume in the data transmission process, and it is unnecessary to transmit the data content of the entire game picture, which reduces the amount of data transmission and improves the efficiency of data processing. For example, in the rendering process of the game picture, the engine plug-in may acquire a piece of game texture data from the target texture queue as a render target, and use game texture data corresponding to the render target to render the game picture. (3) Create the synchronization object corresponding to the game texture data according to the game texture data with reference to the reference synchronization mechanism used in the cloud server. As shown in Table 1 above, synchronization mechanisms such as SharedFence, VK_KHR_external_semaphore_win32, VK_KHR_external_semaphore_fd, and EGL KHR fence_sync may be used to create the synchronization object corresponding to game texture data.

S602: The engine plug-in shares the texture handle and the synchronization object with the image encoder.

The operation for the engine plug-in to share the texture handle and the synchronization object with the image encoder may include: the texture handle and the synchronization object of the game texture data corresponding to the render target may be transmitted to the image encoder through the process communication protocol (for example, an IPC protocol), for the image encoder to acquire the texture handle and the synchronization object. In this manner, the engine plug-in can transmit the texture handle and the synchronization object of the game texture data configured for picture rendering to the image encoder (for example, a GPU encoder) in a video memory sharing manner, which can avoid additional video memory copy operations during image encoding, thereby simplifying the operations, and improving the image processing efficiency of the cloud game.

The engine plug-in may acquire a plurality of to-be-rendered game textures from the target texture queue at one time for unified rendering. The quantity of game textures acquired for unified rendering may be determined according to the type of the target cloud game. For example, if the type of the target cloud game is a shooting type, the quantity of to-be-rendered game textures can be determined by the different types of scene pictures to which a target game character belongs in the target cloud game. For example, a plurality of scene pictures before shooting (for example, a picture of the target game character looking for a target shooting object in the grass) can be rendered in a batch. In another example, a plurality of scene pictures in the shooting process (for example, a picture of a confrontation between the target game character and the target shooting object) may be rendered in batch. In another example, a plurality of scene pictures after shooting (such as a picture of the target game character successfully shooting the target shooting object, or a picture of the target shooting object successfully shooting the target game character) may be rendered by batch. There is a relatively strong correlation between adjacent game pictures in the game scene. Therefore, based on this manner, the engine plug-in may perform batch rendering based on the strong correlation between game pictures, thereby reducing the workload in the rendering process. Subsequently, after batch rendering the game textures to obtain a batch of game texture data, this batch of game texture data may also be transmitted in batch to the image encoder to perform batch encoding on a plurality of game pictures that have been rendered. Similarly, the image encoder may perform batch encoding based on the strong correlation between the game pictures, thereby reducing the workload in the encoding process. The strong correlation herein means that the correlation between two game pictures is greater than a correlation threshold, and the correlation may be the similarity between the two game pictures. In summary, this supports rendering and encoding for batches of game texture data, which can improve the image processing efficiency; and rendering and encoding based on a plurality of strongly correlated game pictures can fully explore the implicit correlation between the various game pictures, thereby improving the accuracy of the encoding process or rendering process for each game picture in the target cloud game.

In the process of batch rendering game pictures described above, a corresponding texture handle and a corresponding synchronization object may be created through association for each batch of game texture data for batch rendering. The texture handle may be associated with game pictures corresponding to a plurality of pieces of game texture data that are batch rendered in this batch. For example, if the game pictures that are batch rendered in this batch are from the first frame to the tenth frame, the created texture handle may be an array (1, 10). In addition, the synchronization object created through association for the plurality of pieces of game texture data in this batch may be configured for indicating the rendering completion status of each piece of game texture data. That is, when it is determined based on the synchronization object that the rendering has been completed, it may be understood as that the game picture corresponding to each piece of game texture data in the batch have been rendered; and when it is determined based on the synchronization object that the rendering has not been completed, it may be understood as that a game picture corresponding to at least one piece of game texture data in the batch has not been rendered.

Subsequently, the engine plug-in may share the texture handles of batches of game texture data and the corresponding synchronization objects with the image encoder, and the image encoder may encode batches of game pictures. For the detailed operations of the engine plug-in and the image encoder for processing batches of game texture data, reference may be made to the detailed processing process for one piece of game texture data discussed in conjunction with FIG. 3.

S603: The image encoder reads the synchronization object.

First, an encoding interface supported by the image encoder may be acquired, one encoding interface supporting parsing synchronization objects correspondingly generated by one or more corresponding synchronization mechanisms. Subsequently, a reference synchronization mechanism associated with the synchronization object corresponding to the game texture data may be acquired. Subsequently, when the synchronization mechanisms supported by the encoding interface include the reference synchronization mechanism, it may be determined that the reading result of the image encoder for the synchronization object is a reading success; otherwise, it may be determined that the reading result of the image encoder for the synchronization object is a reading failure. In other words, whether the image encoder supports reading the synchronization object may be determined based on the encoding interface supported by the image encoder, thereby obtaining the reading result of the image encoder for the synchronization object.

S604: The image encoder acquires the rendering completion status for the game picture from the synchronization object according to the reading result.

In a possible implementation, when the reading result is a reading success, the image encoder may successfully acquire the rendering completion status for the game picture from the synchronization object, then the image encoder may be used to parse the synchronization object, and acquire the rendering completion status for the game picture from the parsed synchronization object.

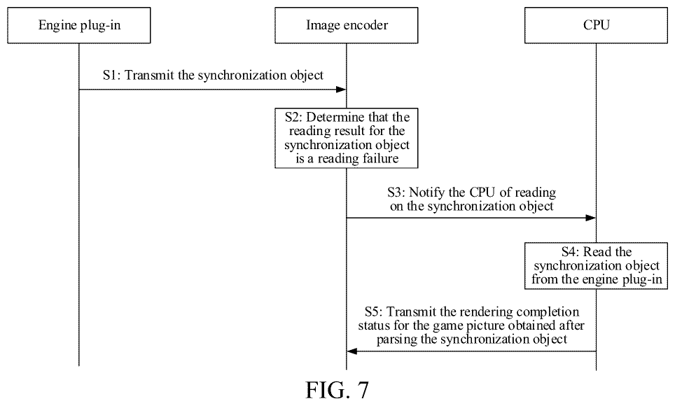

FIG. 7 is a schematic flowchart of one or more aspects of an example of reading a synchronization object. As shown in FIG. 7, when the reading result is a reading failure, the image encoder cannot successfully acquire the rendering completion status for the game picture from the synchronization object, then the operations for the image encoder to acquire the rendering completion status for the game picture from the synchronization object may be the following operations S1 to S5:
S1: The engine plug-in transmits the synchronization object to the image encoder.
S2: The image encoder determines that the reading result for the synchronization object is a reading failure.
S3: The image encoder notifies the CPU of reading on the synchronization object.
S4: The CPU reads the synchronization object from the engine plug-in.
S5: The CPU transmits the rendering completion status for the game picture obtained after parsing the synchronization object to the image encoder.

In this manner, if the image encoder can successfully support reading the synchronization object, the image encoder may read the synchronization object; and if the image encoder cannot successfully support reading the synchronization object, the CPU may read the synchronization object, and then the CPU may notify the image encoder of the rendering completion status for the game picture after reading the synchronization object. In this way, the image encoder and the CPU can efficiently and flexibly make use of their respective roles and functions, thereby improving the efficiency of the image processing process.

S605: If rendering of the game picture is completed, the image encoder encodes the game picture.

Based on the rendering completion status for the game picture, whether the game picture has been rendered may be determined. For example, if the acquired rendering completion status is a rendering progress “100%”, it may be determined that the rendering of the game picture is completed; and in another example, if the acquired rendering completion status is a rendering instruction “end”, it may be determined that the rendering of the game picture is completed. Subsequently, an image encoder may be used to encode the game picture, where the image encoder may include, for example, but not limited to: a GPU encoder, a kubler encoder, or an incremental encoder. The type of the encoder is not specifically limited. Subsequently, after the encoding is completed, image encoded data of the game picture may be generated.

In a possible implementation, after the image encoder encodes the game picture, the image encoded data obtained after the acquired game picture is encoded by using the image encoder may be acquired; and then the image encoded data may be transmitted, based on a real-time communication protocol (for example, web real-time communication (Web RTC)), to a game client running the target cloud game, and a next piece of game texture data may be acquired from the target texture queue for rendering of the game picture. The game client receiving the image encoded data may be configured for outputting the game picture of the target cloud game after decoding the image encoded data. In this manner, after the engine plug-in and the image encoder complete the rendering and encoding of a game picture, the engine plug-in may acquire a next piece of game texture data from the target texture queue again for processes such as rendering of the corresponding game picture and encoding, and the rest may be deduced by analogy, thereby realizing the cloud processing of the target cloud game.

In one instance, the image encoder may encrypt the image encoded data to obtain encrypted encoded data; and then transmit the encrypted encoded data to the game client based on the real-time communication protocol (for example, a WebRTC protocol), for the game client to decrypt the encrypted encoded data to obtain the image encoded data, and output the game picture of the target cloud game after decoding the image encoded data. Based on this manner, during the communication between the cloud server and the game client, the data (image encoded data) may be encrypted and then transmitted, which ensures the reliability and security of the data interaction process.

S606: The image encoder transmits a notification message of encoding completion to the engine plug-in.

After determining that the encoding of the game picture is completed, the image encoder may generate a notification message of encoding completion, and transmit the notification message of encoding completion to the engine plug-in based on an IPC protocol. The notification message of encoding completion may carry the texture handle of the game texture data that has been encoded.

S607: The engine plug-in parses the notification message to obtain the texture handle of the game texture data.

In some instances, the engine plug-in may acquire the notification message of encoding completion from the image encoder, and may parse the notification message to obtain the texture handle of the game texture data that has been encoded.

S608: The engine plug-in adds the game texture data indicated by the texture handle to the target texture queue.

During running of the cloud game, there may be a relatively strong correlation between game pictures, that is, this frame of game picture may be used as the basis for rendering the next frame of game picture. For example, in a shooting game scene, the first frame may be configured for indicating a game picture of pulling the trigger, which may be used as the main basis for rendering the next frame of shooting game picture. Therefore, game texture data that has been encoded (corresponding to rendering one frame of game picture) may be re-added to the target texture queue. The game texture data that has been encoded may be configured for providing reliable picture information for the rendering process of the next game picture. As a result, the image processing process of the cloud game is more accurate. Subsequently, the cloud server may perform processing such as rendering and encoding on the next game picture based on the game texture data. Similarly, the next piece of game texture data that has been encoded may be configured for performing processing such as rendering and encoding on a game picture following the next game picture. Based on this interlocking cloud processing process, the cloud processing process of the target cloud game may be more serialized, so that the game pictures provided in the target cloud game after cloud processing are more accurate and reliable. In addition, the next game picture may be rendered based on the previous piece of game texture data that has been encoded, and due to the correlation between the two adjacent game pictures, the amount of calculation in the rendering process may be reduced, thereby improving the processing efficiency.

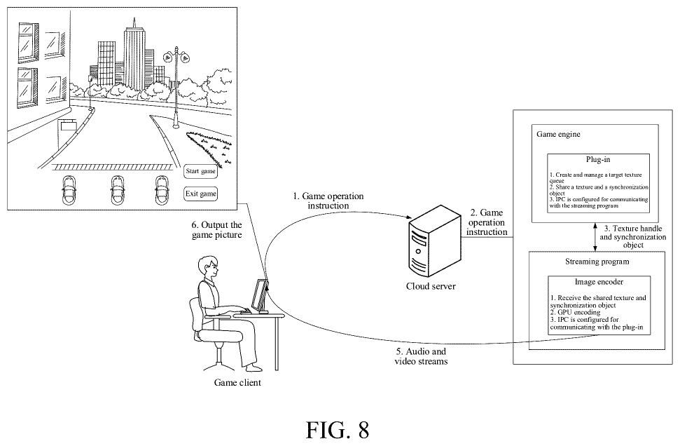

Based on the foregoing description, the image processing method may be applicable to various types of cloud game scenes. FIG. 8 is a schematic diagram of one or more aspects of an example of a scenario of an image processing method for cloud gaming. As shown in FIG. 8, in a cloud game scene, a user may input a game operation instruction for a target cloud game (for example, a racing game or a dancing game) on a game client. For example, the game operation instruction may include: a rotation instruction, a jump instruction, or a movement instruction. After responding to the game operation instruction, the game client may transmit the game operation instruction to a cloud server. After receiving the game operation instruction for the target cloud game, the cloud server may create a target texture queue based on an engine plug-in, acquire a piece of game texture data from the target texture queue for rendering the game picture, and obtain a texture handle and a synchronization object of the game texture data. The engine plug-in may share the texture handle and the synchronization object of the game texture data corresponding to the target cloud game with an image encoder running in a streaming program. The image encoder may acquire a rendering completion status for the game picture from the synchronization object. For example, when the acquired rendering completion status indicates that rendering of the game picture has been completed by using the game texture data, the image encoder may acquire the associated game picture through the texture handle, and may encode the acquired game picture by using the image encoder, to obtain audio and video streams. The streaming program may transmit the audio and video streams to the game client based on a WebRTC protocol. After decoding the received audio and video streams, the game client may display the corresponding game picture.

There may be two independent game processes running in the cloud server, where the engine plug-in runs in one game process, and the image encoder runs in the other game process. The engine plug-in may be configured for being responsible for the rendering logic of game pictures. Compared with the conventional plug-in that needs to be responsible for processing logics such as picture rendering and image encoding, the plug-in as described herein is more lightweight, which reduces the difficulty of plug-in development, thereby facilitating flexible deployment to various game engines. In addition, in the process in which the image encoder and the engine plug-in may share game texture data, the texture handle and the synchronization object corresponding to the game texture data may be shared, which avoids additional video memory copy operations, and simplifies the operations, thereby improving the image processing efficiency.

The foregoing describes the image processing method. To facilitate better implementation of the foregoing solutions, the following correspondingly provides image processing apparatuses. The apparatuses are correspondingly introduced in combination with the image processing method for cloud gaming provided in the foregoing description.

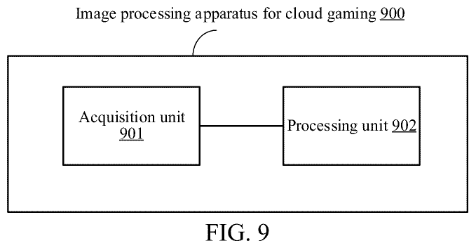

FIG. 9 is a schematic structural diagram of one or more aspects on an example of an image processing apparatus for cloud gaming. As shown in FIG. 9, the image processing apparatus for cloud gaming 900 may be applied to the cloud server discussed above. For example, the image processing apparatus for cloud gaming 900 may be a computer program (including program code) run on a computer device, where the computer device may be the cloud server. For example, the image processing apparatus for cloud gaming 900 may be application software; and the image processing apparatus for cloud gaming 900 may be configured to perform the corresponding operations in the image processing method for cloud gaming provided in this application. The image processing apparatus for cloud gaming 900 may include: an acquisition unit 901, configured to acquire a texture handle and a synchronization object of game texture data in a target cloud game, the texture handle being configured for associating a game picture rendered based on the game texture data, and the synchronization object being configured for indicating a rendering completion status for the game picture by the game texture data; the acquisition unit 901 being further configured to acquire a reading result of an image encoder for the synchronization object, and acquire the rendering completion status for the game picture from the synchronization object according to the reading result; and a processing unit 902, configured to acquire the associated game picture through the texture handle when the acquired rendering completion status indicates that rendering of the game picture has been completed by using the game texture data, and encode the acquired game picture by using the image encoder.

The game texture data may be created by an engine plug-in in the cloud server corresponding to the target cloud game; and the cloud server may further include the image encoder; the engine plug-in and the image encoder in the cloud server may belong to two independent processing processes, and the engine plug-in and the image encoder may interact based on a process communication protocol; and after creating the game texture data, the engine plug-in may transmit the texture handle and the synchronization object of the game texture data to the image encoder based on the process communication protocol.

The processing unit 902 may be further configured to invoke the engine plug-in to arrange a plurality of pieces of created game texture data, to obtain a target texture queue; acquire one piece of game texture data from the target texture queue as a render target, and render the game picture by using the game texture data corresponding to the render target; and transmit a texture handle and a synchronization object of the game texture data corresponding to the render target to the image encoder through the process communication protocol, for the image encoder to acquire the texture handle and the synchronization object.

When the reading result is a reading success, the image encoder may acquire the rendering completion status for the game picture from the synchronization object; and the acquisition unit 901 may be further configured to invoke the image encoder to parse the synchronization object, and acquire the rendering completion status for the game picture from the parsed synchronization object.

When the reading result is a reading failure, the image encoder may be unable to acquire the rendering completion status for the game picture from the synchronization object; and the acquisition unit 901 may be further configured to: parse the synchronization object through a CPU of the cloud server; and transmit the rendering completion status for the game picture obtained after the CPU parses the synchronization object to the image encoder.

The processing unit 902 may be further configured to: acquire an encoding interface supported by the image encoder, one encoding interface supporting parsing synchronization objects generated by one or more corresponding synchronization mechanisms; acquire a reference synchronization mechanism associated with the synchronization object in the game texture data; and when the synchronization mechanisms supported by the encoding interface include the reference synchronization mechanism, determine that the reading result of the image encoder for the synchronization object is a reading success; otherwise, determine that the reading result of the image encoder for the synchronization object is a reading failure.

After encoding the acquired game picture by using the image encoder, the processing unit 902 may be further configured to: generate a notification message of encoding completion, the notification message carrying the texture handle of the game texture data that has been encoded; and invoke the image encoder to transmit the generated notification message of encoding completion to the engine plug-in based on the process communication protocol.

The processing unit 902 may be further configured to: invoke the engine plug-in to parse the notification message to obtain the texture handle of the game texture data that has been encoded; and add the game texture data indicated by the texture handle to the target texture queue.

The game texture data may be to-be-rendered texture data acquired from the target texture queue; and the acquisition unit 901 may be further configured to: render the game picture according to the game texture data, and create the texture handle for the game picture corresponding to the game texture data; and create the synchronization object corresponding to the game texture data according to the game texture data and the reference synchronization mechanism used in the cloud server.

The processing unit 902 may be further configured to: acquire image encoded data obtained after the game picture is encoded; and transmit, based on a real-time communication protocol, the image encoded data to a game client running the target cloud game, acquire a next piece of game texture data adjacent to the game texture data from the target texture queue for rendering of the game picture, and render the game picture according to the next piece of game texture data, the game client being configured for outputting the game picture of the target cloud game after decoding the image encoded data.

The processing unit 902 may be further configured to: encrypt the image encoded data to obtain encrypted encoded data; and transmit the encrypted encoded data to the game client based on the real-time communication protocol, decrypt the encrypted encoded data through the game client to obtain the image encoded data, and output the game picture of the target cloud game after decoding the image encoded data through the game client.

First, a texture handle and a synchronization object of game texture data in a target cloud game may be acquired, the texture handle being configured for associating a game picture rendered based on the game texture data, and the synchronization object being configured for indicating a rendering completion status for the game picture by the game texture data; then a reading result of an image encoder for the synchronization object may be acquired, and the rendering completion status for the game picture may be acquired from the synchronization object according to the reading result; and finally, the associated game picture may be acquired through the texture handle when the acquired rendering completion status indicates that rendering of the game picture has been completed by using the game texture data, and the acquired game picture may be encoded by using the image encoder. It can be seen that in the rendering process of the game picture, a separate image encoder may be responsible for encoding the game picture, so that the encoding process is more flexible. In addition, it is unnecessary to wait for completion of rendering of the game picture before the game picture is transmitted to the image encoder for encoding, but the game handle and the synchronization object associated with the game texture data configured for rendering the game picture may be shared with the image encoder. In this way, after the image encoder determines, based on the synchronization object, that the game picture has been rendered, the image encoder may encode the associated game picture based on the texture handle, making the processing process of the cloud game more flexible and convenient, thereby improving the encoding efficiency of the game picture.

The cloud server discussed above may additionally or alternatively be a computer device. The image processing method for cloud gaming provided in this application may be performed by a computer device. In other words, in addition to using a cloud server to perform the image processing method for cloud gaming, any other feasible computer device may alternatively be used to implement the image processing method for cloud gaming. The computer device will be described herein.

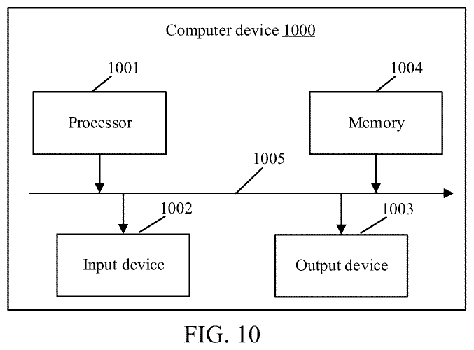

FIG. 10 is a schematic structural diagram of one or more aspects of an example of a computer device. The computer device 1000 is configured to perform the operations performed by the cloud server above. The computer device 1000 includes: one or more processors 1001, one or more input devices 1002, one or more output devices 1003, and a memory 1004. The processor 1001, the input device 1002, the output device 1003, and the memory 1004 are connected through a bus 1005. The processor 1001 (or referred to as a CPU) may be a processing core of the computer device. The processor 1001 may be suitable for implementing one or more program instructions, and may be suitable for loading and executing one or more program instructions to implement the process of the foregoing image processing method for cloud gaming. The memory 1004 may be configured to store a computer program. The computer program includes program instructions. The processor 1001 may be configured to invoke the program instructions stored in the memory 1004, to perform the following operations: acquiring a texture handle and a synchronization object of game texture data in a target cloud game, the texture handle being configured for associating a game picture rendered based on the game texture data, and the synchronization object being configured for indicating a rendering completion status for the game picture by the game texture data; acquiring a reading result of an image encoder for the synchronization object, and acquiring the rendering completion status for the game picture from the synchronization object according to the reading result; and acquiring the associated game picture through the texture handle when the acquired rendering completion status indicates that rendering of the game picture has been completed by using the game texture data, and encoding the acquired game picture by using the image encoder.

The game texture data may be created by an engine plug-in in the cloud server corresponding to the target cloud game; and the cloud server may further include the image encoder; the engine plug-in and the image encoder in the cloud server may belong to two independent processing processes, and the engine plug-in and the image encoder may interact based on a process communication protocol; and after creating the game texture data, the engine plug-in may transmit the texture handle and the synchronization object of the game texture data to the image encoder based on the process communication protocol.

The processor 1001 may be further configured to perform the following operations: invoking the engine plug-in to arrange a plurality of pieces of created game texture data, to obtain a target texture queue; acquiring one piece of game texture data from the target texture queue as a render target, and rendering the game picture by using the game texture data corresponding to the render target; and transmitting a texture handle and a synchronization object of the game texture data corresponding to the render target to the image encoder through the process communication protocol, for the image encoder to acquire the texture handle and the synchronization object.

When the reading result is a reading success, the image encoder may acquire the rendering completion status for the game picture from the synchronization object; and the processor 1001 may be further configured to perform the following operations: invoking the image encoder to parse the synchronization object, and acquiring the rendering completion status for the game picture from the parsed synchronization object.

When the reading result is a reading failure, the image encoder may be unable to acquire the rendering completion status for the game picture from the synchronization object; and the processor 1001 may be further configured to perform the following operations: parsing the synchronization object through a CPU of the cloud server; and transmitting the rendering completion status for the game picture obtained after the CPU parses the synchronization object to the image encoder.

The processor 1001 may be further configured to perform the following operations: acquiring an encoding interface supported by the image encoder, one encoding interface supporting parsing synchronization objects generated by one or more corresponding synchronization mechanisms; acquiring a reference synchronization mechanism associated with the synchronization object in the game texture data; and when the synchronization mechanisms supported by the encoding interface include the reference synchronization mechanism, determining that the reading result of the image encoder for the synchronization object is a reading success; otherwise, determining that the reading result of the image encoder for the synchronization object is a reading failure.

After encoding the acquired game picture by using the image encoder, the processor 1001 may be further configured to perform the following operations: generating a notification message of encoding completion, the notification message carrying the texture handle of the game texture data that has been encoded; and invoking the image encoder to transmit the generated notification message of encoding completion to the engine plug-in based on the process communication protocol.

The processor 1001 may be further configured to perform the following operations: invoking the engine plug-in to acquire the notification message of encoding completion from the image encoder, and parsing the notification message to obtain the texture handle of the game texture data that has been encoded; and adding the game texture data indicated by the texture handle to the target texture queue.

The game texture data may be to-be-rendered texture data acquired from the target texture queue; and the processor 1001 may be further configured to perform the following operations: rendering the game picture according to the game texture data, and creating the texture handle for the game picture corresponding to the game texture data; and creating the synchronization object corresponding to the game texture data according to the game texture data and the reference synchronization mechanism used in the cloud server.

After encoding the acquired game picture by using the image encoder, the processor 1001 may be further configured to perform the following operations: acquiring image encoded data obtained after the game picture is encoded; and transmitting, based on a real-time communication protocol, the image encoded data to a game client running the target cloud game, acquiring a next piece of game texture data adjacent to the game texture data from the target texture queue, and rendering the game picture according to the next piece of game texture data, the game client being configured for outputting the game picture of the target cloud game after decoding the image encoded data.

The processor 1001 may be further configured to perform the following operations: encrypting the image encoded data to obtain encrypted encoded data; and transmitting the encrypted encoded data to the game client based on the real-time communication protocol, decrypting the encrypted encoded data through the game client to obtain the image encoded data, and outputting the game picture of the target cloud game after decoding the image encoded data through the game client.

In one example, in the rendering process of the game picture, a separate image encoder may be responsible for encoding the game picture, so that the encoding process is more flexible. In addition, it is unnecessary to wait for completion of rendering of the game picture before the game picture is transmitted to the image encoder for encoding, but the game handle and the synchronization object associated with the game texture data configured for rendering the game picture are shared with the image encoder, so that after the image encoder determines, based on the synchronization object, that the game picture has been rendered, the image encoder can encode the associated game picture based on the texture handle, making the processing process of the cloud game more flexible and convenient.

In addition, this application further provides a non-transitory computer storage medium. The computer storage medium stores a computer program, and the computer program includes computer-readable program instructions. When executing the program instructions, a processor may perform the methods discussed above. For example, the program instructions may be deployed on a computer device, or deployed to be executed on a plurality of computer devices at the same location, or deployed to be executed on a plurality of computer devices that are distributed in a plurality of locations and interconnected via a communication network.

A computer program product is also provided, the computer program product including a computer program, the computer program being stored in a computer-readable storage medium. A processor of a computer device reads the computer program from the computer-readable storage medium, and executes the computer program, so that the computer device can perform the methods discussed above.

A person of ordinary skill in the art may understand that all or some of the processes of the methods may be implemented by a computer program instructing relevant hardware. The program may be stored in a computer-readable storage medium. When the program is executed, the processes of the foregoing methods may be performed. The foregoing storage medium may be a magnetic disk, an optical disc, a read-only memory (ROM), or a random access memory (RAM).

What is disclosed above is merely exemplary aspects of this application, and certainly is not intended to limit the scope of the claims of this application. Therefore, equivalent variations made in accordance with the claims of this application shall fall within the scope of this application.

What is claimed is:

1. A method comprising:
obtaining, by a cloud server, a texture handle and a synchronization object of game texture data for a target game running on the cloud server, the texture handle indicating a game picture rendered based on the game texture data, and the synchronization object indicating a rendering completion status for the game picture by the game texture data;
obtaining a reading result of an image encoder for the synchronization object;
obtaining, using the reading result, a rendering completion status for the game picture from the synchronization object;
obtaining the game picture indicated by the texture handle based on the rendering completion status indicating that rendering of the game picture has been completed by using the game texture data; and
encoding, using the image encoder, the game picture.

2. The method according to claim 1, wherein the cloud server comprises the image encoder, the method further comprising:
generating, by an engine plug-in in the cloud server corresponding to the target game, the game texture data; and
transmitting, by the engine plug-in, to the image encoder and using a process communication protocol, the texture handle and the synchronization object of the game texture data,
wherein the engine plug-in and the image encoder in the cloud server belong to two independent processing processes, and
wherein the engine plug-in and the image encoder interact based on the process communication protocol.

3. The method according to claim 2, further comprising:
invoking the engine plug-in to arrange a plurality of generated game texture data, to obtain a target texture queue;
obtaining first game texture data from the target texture queue as a render target;
rendering the game picture by using the first game texture data corresponding to the render target; and
transmitting a texture handle and a synchronization object of the game texture data corresponding to the render target to the image encoder through the process communication protocol.

4. The method according to claim 3, wherein based on the reading result indicating a reading success, the method further comprises:
acquiring, by the image encoder, the rendering completion status for the game picture from the synchronization object by:
invoking the image encoder to parse the synchronization object; and
acquiring the rendering completion status for the game picture from the parsed synchronization object.

5. The method according to claim 4, wherein based on the reading result indicating a reading failure, the acquiring the rendering completion status for the game picture from the synchronization object according to the reading result comprises:
parsing the synchronization object through a central processing unit (CPU) of the cloud server; and
transmitting the rendering completion status for the game picture obtained after the CPU parses the synchronization object to the image encoder.

6. The method according to claim 5, further comprising:
acquiring an encoding interface supported by the image encoder, wherein the encoding interface parses synchronization objects generated by one or more synchronization mechanisms;
acquiring a reference synchronization mechanism associated with the synchronization object in the game texture data;
determining, based on the one or more synchronization mechanisms comprising the reference synchronization mechanism, that the reading result of the image encoder for the synchronization object is a reading success; and
determining, based on the one or more synchronization mechanisms not comprising the reference synchronization mechanism, that the reading result of the image encoder for the synchronization object is a reading failure.

7. The method according to claim 6, the method further comprising:
generating, after encoding the game picture, a notification message of encoding completion, the notification message comprising the texture handle of the game texture data that has been encoded; and
invoking the image encoder to transmit the notification message to the engine plug-in based on.

8. The method according to claim 7, further comprising:
invoking the engine plug-in to parse the notification message to obtain the texture handle of the game texture data that has been encoded; and
adding the game texture data indicated by the texture handle to the target texture queue.

9. The method according to claim 8, wherein the game texture data is to-be-rendered texture data acquired from the target texture queue, and wherein the acquiring a texture handle and a synchronization object of game texture data in a target game comprises:
rendering the game picture according to the game texture data;
creating the texture handle for the game picture corresponding to the game texture data; and
creating the synchronization object corresponding to the game texture data according to the game texture data and the reference synchronization mechanism used in the cloud server.

10. The method according to claim 3, wherein after the encoding the game picture by using the image encoder, the method further comprises:
obtaining next image encoded data; and
transmitting, using on a real-time communication protocol, the next image encoded data to a game client running the target game;
obtaining a next piece of game texture data adjacent to the game texture data from the target texture queue; and
rendering the game picture according to the next piece of game texture data.

11. The method according to claim 10, further comprising:
encrypting the image encoded data to obtain encrypted encoded data; and
transmitting the encrypted encoded data to the game client using the real-time communication protocol;
decrypting the encrypted encoded data through the game client to obtain the image encoded data; and
causing to be output the game picture of the target game.

12. An apparatus comprising:
one or more processors; and
memory storing computer-readable instructions that when executed by the one or more processors, cause the apparatus to:
obtain a texture handle and a synchronization object of game texture data for a target game running on a cloud server, the texture handle indicating a game picture rendered based on the game texture data, and the synchronization object indicating a rendering completion status for the game picture by the game texture data;
obtain a reading result of an image encoder for the synchronization object;
obtain, using the reading result, a rendering completion status for the game picture from the synchronization object;
obtain the game picture indicated by the texture handle based on the rendering completion status indicating that rendering of the game picture has been completed by using the game texture data; and
encode, using the image encoder, the game picture.

13. The apparatus according to claim 12, wherein the apparatus comprises the image encoder, the memory storing instructions that when executed by the one or more processors further cause the apparatus to:
generate, by an engine plug-in in the cloud server corresponding to the target game, the game texture data; and
transmit, by the engine plug-in, to the image encoder and using a process communication protocol, the texture handle and the synchronization object of the game texture data,
wherein the engine plug-in and the image encoder in the cloud server belong to two independent processing processes, and
wherein the engine plug-in and the image encoder interact based on the process communication protocol.

14. The apparatus according to claim 13, the memory storing instructions that when executed by the one or more processors further cause the apparatus to:
invoke the engine plug-in to arrange a plurality of generated game texture data, to obtain a target texture queue;
obtain first game texture data from the target texture queue as a render target;
render the game picture by using the first game texture data corresponding to the render target; and
transmit a texture handle and a synchronization object of the game texture data corresponding to the render target to the image encoder through the process communication protocol.

15. The apparatus according to claim 13, the memory storing instructions that when executed by the one or more processors further cause the apparatus to:
obtain, by the image encoder, the rendering completion status for the game picture from the synchronization object by:
invoking the image encoder to parse the synchronization object; and
acquiring the rendering completion status for the game picture from the parsed synchronization object.

16. The apparatus according to claim 14, wherein based on the reading result indicating a reading failure, the obtaining the rendering completion status for the game picture from the synchronization object according to the reading result comprises:
parsing the synchronization object through a central processing unit (CPU); and
transmitting the rendering completion status for the game picture obtained after the CPU parses the synchronization object to the image encoder.

17. A non-transitory computer-readable medium storing instructions that when executed by one or more processors, cause the one or more processors to:
obtain a texture handle and a synchronization object of game texture data for a target game running on a cloud server, the texture handle indicating a game picture rendered based on the game texture data, and the synchronization object indicating a rendering completion status for the game picture by the game texture data;
obtain a reading result of an image encoder for the synchronization object;
obtain, using the reading result, a rendering completion status for the game picture from the synchronization object;
obtain the game picture indicated by the texture handle based on the rendering completion status indicating that rendering of the game picture has been completed by using the game texture data; and
encode, using the image encoder, the game picture.

18. The non-transitory computer-readable medium according to claim 17, wherein the apparatus comprises the image encoder, the memory storing instructions that when executed by the one or more processors further cause the one or more processors to:
generate, by an engine plug-in in the cloud server corresponding to the target game, the game texture data; and
transmit, by the engine plug-in, to the image encoder and using a process communication protocol, the texture handle and the synchronization object of the game texture data,
wherein the engine plug-in and the image encoder in the cloud server belong to two independent processing processes, and
wherein the engine plug-in and the image encoder interact based on the process communication protocol.

19. The non-transitory computer-readable medium according to claim 18, the memory storing instructions that when executed by the one or more processors further cause the one or more processors to:
invoke the engine plug-in to arrange a plurality of generated game texture data, to obtain a target texture queue;
obtain first game texture data from the target texture queue as a render target;
render the game picture by using the first game texture data corresponding to the render target; and
transmit a texture handle and a synchronization object of the game texture data corresponding to the render target to the image encoder through the process communication protocol.

20. The non-transitory computer-readable medium according to claim 18, the memory storing instructions that when executed by the one or more processors further cause the one or more processors to:
obtain, by the image encoder, the rendering completion status for the game picture from the synchronization object by:
invoking the image encoder to parse the synchronization object; and
acquiring the rendering completion status for the game picture from the parsed synchronization object.
